(19) United States
(12) Patent Application Publication
(10) Pub. No.: US 2010/0093491 A1
(43) Pub. Date: Apr. 15, 2010

(54) DEVICE FOR CONVERTING LINEAR MOTION INTO A ROTATIONAL MOTION IN AN ADJUSTABLE WAY

(75) Inventor: Jean Christian Robert, Boulogne Billancourt (FR)

Correspondence Address: YOUNG & THOMPSON, 209 Madison Street, Suite 500, Alexandria, VA, 22314, US

(73) Assignee: SOCIETE ROBERT, JEAN-CHRISTIAN, Boulogne-Billancourt (FR)

(21) Appl. No.: 12/443,038

(22) PCT Filed: Sep. 25, 2007
(86) PCT No.: PCT/FR07/01572

§ 371 Date: Nov. 17, 2009

(30) Foreign Application Priority Data
Sep. 26, 2006 (FR) 0608457

(51) Int. Cl. F02N 15/00; F16H 21/22

(52) U.S. Cl. 477/167; 74/44

(57) ABSTRACT

A device includes a driving or driven rotating shaft (AM) of axis (XX′), at least one piston (P₁) which slides in a cylinder (C₁) of axis (X₁X₁′) separate from the axis (XX′), an oscillating structure (SO) having a protuberance of axis (YY′) and being able to oscillate by a universal joint that prohibits its rotation about the axis (YY′), at least one link rod which transmits the forces between the piston and a point (CS′₁, CS′₂) on the oscillating structure such that when the piston (P₁) moves, the axis (YY′) sweeps a cone of axis (XX′), a crankshaft (V) turning about the axis (XX′), articulated connection (F) between the oscillating structure (SO) and the crankshaft (V), an adjusting device which causes the connection means to pivot, resulting in a variation in the level of compression or cylinder capacity of the device.

### BACKGROUND OF THE INVENTION

1. Field of the Invention

The object of the invention is a device for converting a linear movement into a rotational movement in an adjustable way.

It is particularly well suited, but not exclusively, to axial cylinder engines (also called axial engines) for which it is preferable to be able to control the compression ratio and/or cylinder capacity in order to optimize the performances of the engine. This type of engine may advantageously be used in the field of automobiles where it is important to have engines which may accept many kinds of fuels, operating in an optimal way at various engine speeds, and for different engine torques.

The invention is not limited to this type of application: it may for example also be applied to pumps for which it is of interest to vary the compression ratio and/or cylinder capacity and consequently the maximum pressure and the flow rate.

2. Description of the Prior Art

It is known that there are many kinds of conversion of motions. Conversion of an alternating movement into a rotational movement of the connecting rod/crank type is well known and has been used in locomotives and internal combustion engines for a very long time.

Conventional internal combustion engines of the connecting rod/crank type have an architecture which does not lend itself to system integration allowing variable compression ratio or variable cylinder capacity. Attempts in this direction lead to cumbersome and expensive heavy devices.

So-called axial cylinder engines have also been proposed which generally comprise three to five cylinders arranged in an engine block. The pistons housed in these cylinders actuate an oscillating structure. This oscillating structure comprises a ball joint fixed relatively to the engine block. An appendage of this oscillating structure is then driven into rotation around the engine axis. These engines however have drawbacks which make them slightly less attractive than conventional engines with connecting rod/crank.

In addition, these axial cylinder engines do not comprise adjustment means with which they may be effectively adapted notably to the type of fuel, to the actual octane index of the fuel, to the temperature of the fuel, to the density of the fuel, to the engine temperature, to the engine speed, to the variations in the engine speed, to the engine torque, or even to the air intake pressure.

### OBJECT OF THE INVENTION

The object of the present invention is to find a remedy to these drawbacks by proposing a device with which the in-use performances of the engines or of the axial cylinder pumps may be improved and for making them more performing than conventional engines with connecting rod/crank.

### SUMMARY OF THE INVENTION

For this purpose, it proposes a device with a structure similar to that of an axial cylinder engine or pump, this device comprising:

a fixed structure

a rotary shaft which may be driving in the case of an engine and driven in the case of a pump, this rotary shaft having a main axis XX′

at least one cylinder with an axis X₁X′₁ distinct from the main axis XX′, this cylinder being fixed relatively to the fixed structure

at least one piston slidably mounted inside said cylinder, this piston comprising a load-spreading point

an oscillating structure comprising an appendage of axis YY′, this structure being mounted so as to oscillate around a supporting point firmly attached to the fixed structure and located on said main axis XX′

a Cardan joint or analogous link placed between the fixed supporting point and a corresponding attachment point of the oscillating structure for ensuring translational fixedness of the oscillating structure while preventing its rotation around its YY′ axis,

at least one small connecting rod transmitting the forces between the load-spreading point of the piston and a load-spreading point provided on the oscillating structure, so that when the piston moves in the cylinder, the axis YY′ of the oscillating structure sweeps through a cone of axis XX′ and of apex O and a load-spreading point provided on the appendage follows a circle of centre C located on the XX′ axis and with radius R

a crankshaft associated with the rotary shaft and which may rotate around the axis XX′, this crankshaft comprising a load-spreading point, decentred relatively to the main axis XX′

jointed connecting means between the load-spreading point located on the appendage of the oscillating structure and the load-spreading point located on the crankshaft.

According to the invention, this device is characterized in that:

said jointed connecting means comprise at least two joints connected to each other through a connecting member, both of these joints being with axes parallel to each other and perpendicular to said main axis XX′

it comprises an adjustment device involving an actuator comprising a jointed actuation unit on said connecting member so as to cause tipping over of said rigid connecting member and accordingly a variation of said radius R, and of the compression ratio and/or cylinder capacity of the device.

Advantageously,

the actuation unit may consist in the rotary shaft, said shaft being rotatably mounted while being axially mobile, actuating means being provided for axially displacing said shaft,

the actuation unit may consist in a cylindrical actuator positioned between said connecting member and said crankshaft, this cylinder actuator being able to be incorporated to said shaft.

Moreover, the following means may be integrated to the device described earlier:

means for varying the value of the radius R so that the engine efficiency is permanently adjusted in an optimum way, i.e. this engine operates at a maximum compression ratio, while remaining below that for occurrence of the detonating combustion phenomenon, commonly called pinking, as soon as this phenomenon is detected on the engine and at any moment during its operation, this means for varying the value of the radius R may for example consist of a servocontrol acting automatically and instantaneously, regardless of the variations in the conditions of use of this engine, and regardless of the movements of any internal or external members having an influence on the operation of this engine.

means for varying the value of the radius R depending on the strength of the mixture admitted into the cylinders,

means modifying the value of the radius R depending on a command from the operator,

the value of the radius R is adjusted once and for all in the factory in order to correspond to a type of engine operation,

the value of the radius R is adjustable by the operator when the engine is stopped in order to take into account the type of fuel used for example.

the value of the radius R may vary depending on the engine speed.

the value of the radius R may vary depending on the engine torque.

the value of the radius R may vary depending on the operating temperature,

the value of the radius R may vary depending on the temperature of the burnt gases.

### BRIEF DESCRIPTION OF THE DRAWINGS

Embodiments of the invention will be described hereafter as non-limiting examples, with reference to the appended drawings wherein:

FIGS. 1 and 2 are schematic axial sectional views of an axial cylinder engine comprising the device according to the invention, the crankshaft being in the high position (FIG. 1) and in the low position (FIG. 2).

FIG. 3 schematically shows a sectional view of an exemplary embodiment according to the invention of the driving of the crankshaft into rotation by the oscillating structure.

FIG. 4 schematically shows a top view of an exemplary embodiment according to the invention of the driving of the crankshaft into rotation by the oscillating structure (the portion belonging to the oscillating structure being omitted).

FIGS. 5 and 6 are two schematic sectional views of an alternative embodiment of an axial cylinder engine according to the invention:

FIG. 5 illustrating the engine adjusted for zero compression ratio (disabled pistons),

FIG. 6 illustrating this engine adjusted for maximum compression ratio.

FIG. 7 is a schematic axial sectional view of an axial cylinder engine of the type of the one illustrated in FIGS. 5 and 6, equipped with a system with an external self-servocontrol.

FIG. 8 is a coaxial sectional view of an alternative embodiment illustrated in FIG. 7 wherein the regulation system is incorporated to the crankshaft.

### DESCRIPTION OF THE PREFERRED EMBODIMENT

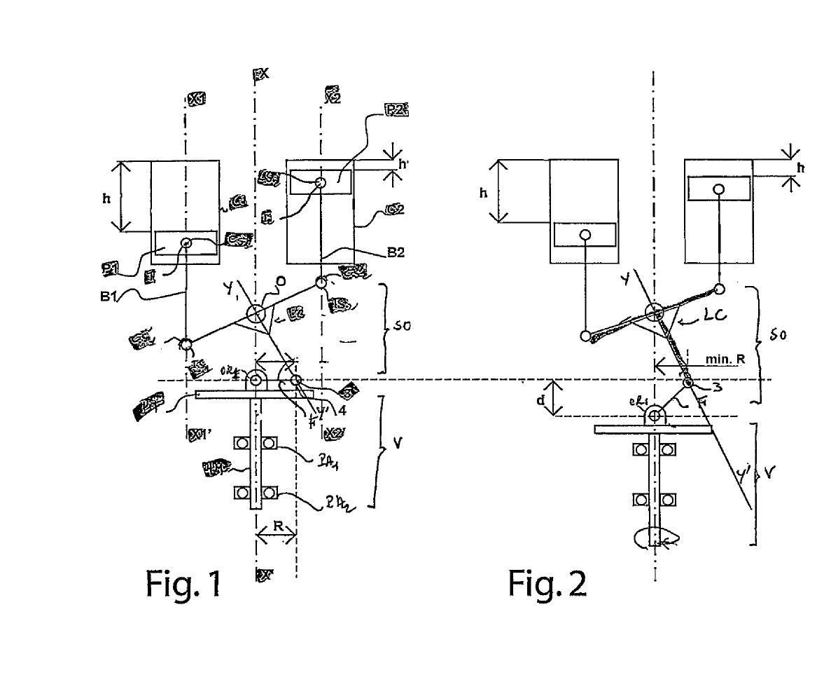

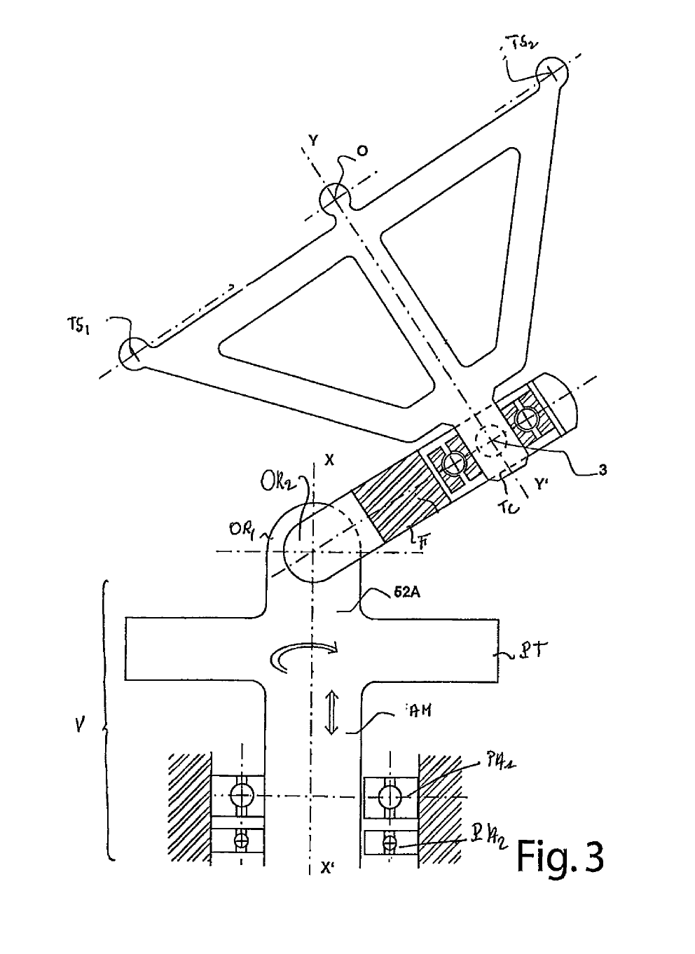

In the example illustrated in FIGS. 1-4, the engine comprises a plurality of cylinders, for example four barrel-arranged cylinders within an engine block (not shown). These cylinders are centred with an axis parallel to an engine axis XX′ and are inscribed in a cylinder coaxial with the engine axis XX′.

In FIGS. 1 and 2, only the two cylinders C₁, C₂ with axes X₁X′₁ and X₂X′₂ through which the sectional plane passes, are visible. Inside each of these cylinders C₁, C₂, a piston P₁, P₂ is slidably mounted, comprising a cylindrical sealed surface and a spherical cavity CS₁, CS₂ preferably placed at its centre.

The spherical head T₁, T₂ of a connecting rod B₁, B₂, the other end of which comprises a spherical cavity CS′₁, CS′₂, engages into each of the spherical cavities CS₁, CS₂.

On the engine axis XX′, the engine block comprises an anchoring point O on which an oscillating structure SO is mounted via a Cardan joint link LC or the like (not shown in detail).

This oscillating structure SO has a pyramidal shape for example with a square base of axis YY′. At each apex of the base a spherical head TS₁, TS₂ is placed, intended to engage into a corresponding spherical cavity CS′₁, CS′₂ of a small connecting rod B₁, B₂. At the centre of the base, the oscillating structure SO comprises an attachment point on which the Cardan joint link LC will be attached.

This Cardan joint link LC prevents linear displacements of the attachment point of the oscillating structure relatively to the engine block, and rotations relative to the XX′ axis, while leaving the oscillating structure SO free to oscillate about both other axes of rotation.

At the top 3 of the oscillating structure SO a cylindrical section TC of axis YY′ (coaxial with the structure SO) is provided connected to a crankshaft V via a mechanical link, here a rigid connecting fork F.

The crankshaft V comprises a rotating circular plate PT of axis XX′ mounted at one end of the fluted coaxial engine shaft AM mounted on two bearings PA₁, PA₂ both allowing rotation of the crankshaft V and its translational displacement along the axis XX′. On the side opposite to the shaft AM, the plate PT is provided with two diametrically opposite lugs OR₁, respectively provided with two coaxial radial bores forming a joint yoke.

The connecting fork F on the one hand comprises on one side two parallel lugs OR₂ distant from each other respectively provided with two respective coaxial cylindrical holes of axes UU′ and on their outer faces, a supporting face and, on the other hand, on the other side, a load-spreading link LR comprising a ring-shaped bearing R₁, for example a ball or roller bearing, mounted on the fork F so as to pivot about an axis ZZ′ perpendicular to the axis of rotation of said bearing R₁.

Both lugs OR₂ of the fork F engage between both lugs OR₁ of the plate PT so that the bores are positioned coaxially with the holes and may be crossed by a common joint axis AC.

The cylinder section TC will closely engage into the free space delimited by the central crown 54 of the bearing R₁, so that the protrusion of the oscillating structure is firmly attached to said central crown 51.

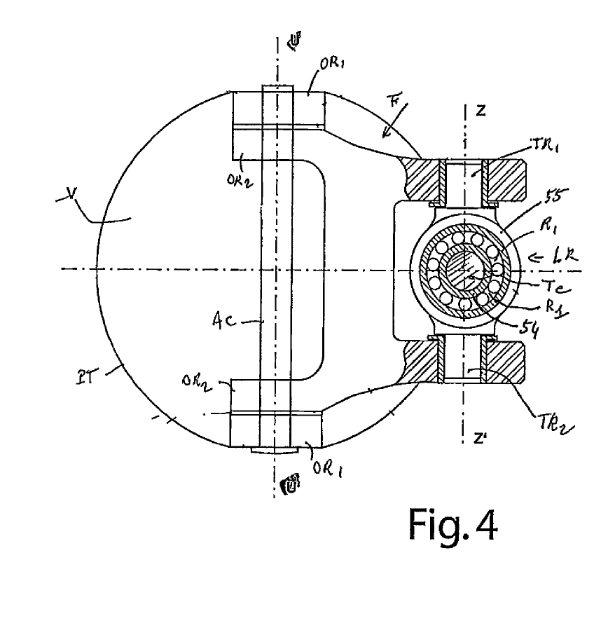

The load-spreading link LR may for example as illustrated in FIG. 4 comprise a circular cage 55, which receives at its centre a ball or roller bearing R₁ or else a lubricated bearing in order to allow fast rotation of both bearing crowns or of the bearing about the axis YY′, the frequency of rotation about this axis being the same as the frequency of rotation of the engine. The circular cage 55 on two diametrically opposite locations also comprises trunnions TR₁, TR₂ positioned along an axis ZZ′ perpendicular to YY′. Both of these trunnions TR₁, TR₂ are supported by two coaxial bearings firmly attached to the fork F and allowing the cage 55 to pivot relatively to the fork F about the axis ZZ′. The relative displacements between the cage 55 and the fork F depend on the imposed constraints for adjusting the engine. The lubrication constraints on these connections are therefore much less severe than on the axis YY′.

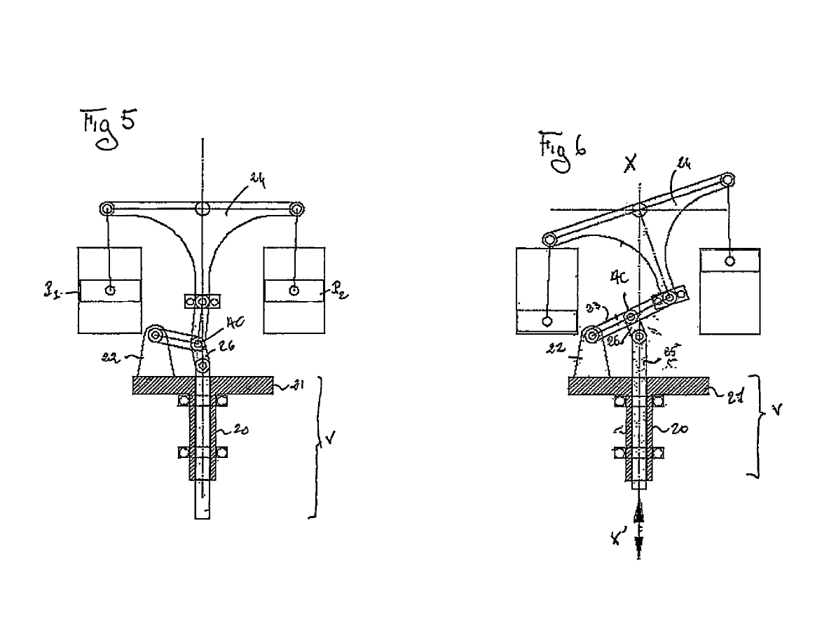

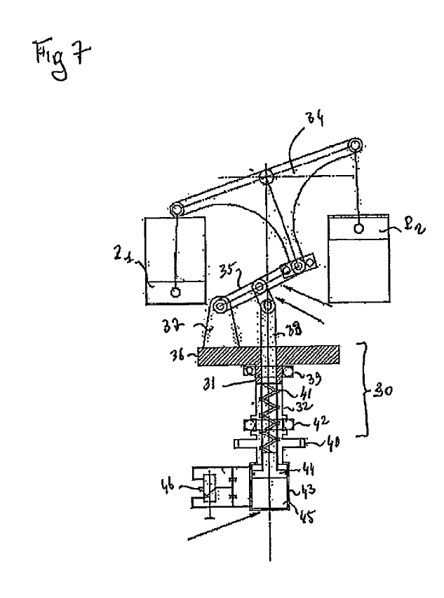

In the example illustrated in FIGS. 5 and 6, the rotary assembly comprising the engine shaft 20 and the plate 21 is axially fixed. The plate 21 comprises a decentred joint yoke 22 on which one of the ends of a fork 23 similar to the fork F of the embodiment illustrated in FIGS. 1-4 will be jointed. The other end of the fork F is connected to the top of an oscillating structure 24 similar to the structure SO.

However in this case, the fork connecting member is made in two parts assembled with each other by means of a central joint AC with an axis parallel to the axes of both joints of the fork.

Adjustment of the radius R is then obtained by varying the angle formed between both parts of the fork 23. This adjustment may be achieved by means of an actuator, for example a hydraulic or electric actuator provided between the plate and the fork or even by means of a cylinder actuator incorporated to the engine axis 20. In the example illustrated in FIGS. 5 and 6, the engine shaft 20 is tubular and delimits a central cylindrical passage through which an adjustment rod 25 engages and slides axially, one of the ends of which is connected to the fork via a connecting rod 26, one end of which is jointed to the rod 25 while the other end is jointed to the fork 23, at the central joint AC, about the same joint axis as the latter.

By bringing the oscillating structure right up to a position where its base is perpendicular to the engine axis (zero compression ratio), the pistons may be entirely disabled, i.e. a sort of declutching of the engine may be achieved: in this position of the plate as illustrated in FIG. 5, the pistons P₁, P₂ as well as the oscillating structure 24 are therefore stationary, while the crankshaft V, the driving axis 20, as well as the inertial flywheel, formed by the plate PT of the crankshaft V, may continue to freely rotate. As the assembly may easily be mounted on ball bearings, therefore with low friction, the kinetic energy contained in the rotating masses may be retained for some time and possibly utilized subsequently.

The main advantage of being able to vary the compression ratio of an internal combustion engine with controlled ignition lies in the possibility of permanently adapting the efficiency of the engine depending on its use (the compression ratio should be high in order to improve efficiency, but reduced when the required torque or operating speed or temperature are high in order to avoid the pinking phenomenon). The possibility of varying the compression ratio comprises other related advantages:
adaptation of the engine to various qualities or various kinds of fuels, mineral, vegetable fuels . . . , which have very different properties in terms of density, temperature, octane index . . .
adaptation depending on the pressure of the intake air (altitude, turbocompress or . . . )
facilitate the starting of diesel engines
adapt the outlet temperature of the exhausted gases in order to promote catalytic post-treatment of these gases.

As for the disabling of the pistons P₁, P₂, this may be very useful for certain motorization configurations:
upon starting the engine, the inertial flywheel (rotating masses) may be launched, the pistons disengaged, just before actual starting of the engine, thereby reducing the instantaneous power required on the starter, therefore the weight of this starter, or else facilitating the introduction of an alterno-starter directly meshed with the engine shaft (reduction in weight, suppression of transmission belts and therefore of friction),
on so-called “stop and go” systems, where the engine is stopped when the vehicle is momentarily at a standstill, in order to reduce fuel consumption, the disengagement of the sole pistons may facilitate restarting of the engine with the retained kinetic energy subsequently released by the rotating masses,
in hybrid motorization systems, where the heat engine is coupled with another energy converter (electrical, pneumatic, hydraulic energy converter . . . ) which is capable of operating as a receiver and transmitter in order to convert, store and release the mechanical braking energy of the vehicle; by disabling the sole pistons it is more easy to manage the transition from one to the other of the motorizations, without adding a frictional gear or other more complex systems presently known on such hybrid motorizations.

It is recalled that on alternating engines there are two types of forces which appear at the mechanism which converts the alternating movement of the pistons into a rotational movement: a tangential force which fully participates in generating an engine torque, and an inevitable radial force, which may however be considered as parasitic, since it does not contribute to generating an engine torque, and dimensioning of the structure of the engine in order to deal with this becomes mandatory. This phenomenon is encountered on any type of alternating engine, with the same values, whether it is of the connecting rod/crank or cylindricalbarrel/oscillating structure type.

The radial force is of the alternating sawtooth-shaped type, it passes through a very large maximum upon explosion of the gases, about 3 tons for a medium engine, then decreases during rotation and may pass through a slightly negative value depending on the number of cylinders and on the engine cycle (this for example is the case for 4 stroke/5 cylinder engine).

The tangential force which generates the engine torque is also of the alternating type, with extreme values which are less significant than for the radial force, and with a shape closer to a sine wave. It is found that in the fields of application concerned by the present invention, the maximum value of the tangential force approximately corresponds to the minimum value of the radial force and vice versa.

The invention benefits from both of these antagonistic forces but which are non-simultaneous in order to control the rod 25 for adjusting the inclination of the oscillating structure 24: the radial force tends to push the adjustment rod 25 back by thus reducing the angle of the oscillating structure 24. The invention therefore provides a device, for example a mechanical, hydraulic device . . . which utilizes part of the transmitted engine torque in order to transmit in turn to the adjustment rod a force opposite to the force induced by the radial force and which therefore tends to increase the inclination angle of the oscillating structure 2. An unstable system is therefore obtained, which will have the tendency of oscillating if it is left free. A regulator is therefore used, controlled from the outside which allows this assembly to be driven. This regulator is designed so as to have three types of operation: it blocks the system in a determined adjustment position, or else it allows the movement of the rod in one direction or in the other direction. When this regulator is active, it acts therefore as an electric rectifier by “letting through” one of the forces originating from the radial force or from the tangential force and blocks the other one. Once the system has reached the desired adjustment position, the regulator is placed back in its rest position which prevents any movement.

An entirely standalone device is therefore obtained which may operate without providing it with any external energy, all the energy required for controlling the system being provided by the engine itself. As the energy for controlling the regulator is considered as negligible (for example the energy required for actuating a distributor drawer in the case of a hydraulic regulation system), a few engine turns may be sufficient for changing the adjustment position, which is of the order of 1/100 or 1/10 second: indeed it is important in order to fully utilize the benefit of variable compression, to have a very short response time depending on the load on the engine.

The control of the regulator may be of a quite conventional type and is accordingly not illustrated. Ideally, a series of sensors (for the speed of rotation of the engine, the temperature, the transmitted torque . . . ) transmit signals to an electronic computer, and then an electric control drives the regulator. However, any other type of sensor controls, for example mechanical ones . . . may be contemplated.

If the engine is exclusively used in the variable compression domain, it is not absolutely necessary to intervene on the distribution and injection, on the other hand if the adjustment is used until the engine is declutched (zero compression ratio), a system needs to be provided in order to disable the distribution, and especially the injection, when the engine leaves its operating domain. This device may be of any nature, mechanical, hydraulic, electric . . . and may be directly coupled to the rod for adjusting the plate inclination or to any other intermediate system in order to take the actual inclination of the plate into account.

In the case when the transmitted torque becomes negative (on a motor vehicle, this is then termed as “engine braking”), the force transmitted to the rod is reversed, and if this is allowed by the external drive which controls the regulator, the inclination of the oscillating structure is reduced, right up to a position perpendicular to the axis, thereby achieving rapid declutching of the engine. Of course on a motor vehicle, this position is only contemplated if hybrid type motorization is available, the second engine(or motor)/receiver then taking over in order to accumulate braking energy, avoiding that the vehicle be left freewheeling.

Upon starting the engine, the transmitted torque is also negative (as seen from the engine), which may therefore cause always under the control of an external drive, declutching of the engine, and setting into rotation of the single crankshaft V by the starter. It is then sufficient when the crankshaft reaches a sufficient speed of rotation, to provide a disengageable device, for example actuated by the inertia of the crankshaft, which pushes the adjustment rod 25 back in order to have a suitable inclination of the oscillating structure 24. This accessory starting device (electric starter drive type) then withdraws and the engine is again found in configurations described earlier. With this 2-phase (but fast) starting device provision may be made for a starter with a lower power than a conventional starter, starting is facilitated and it also allows the design of a simplified alternostarter.

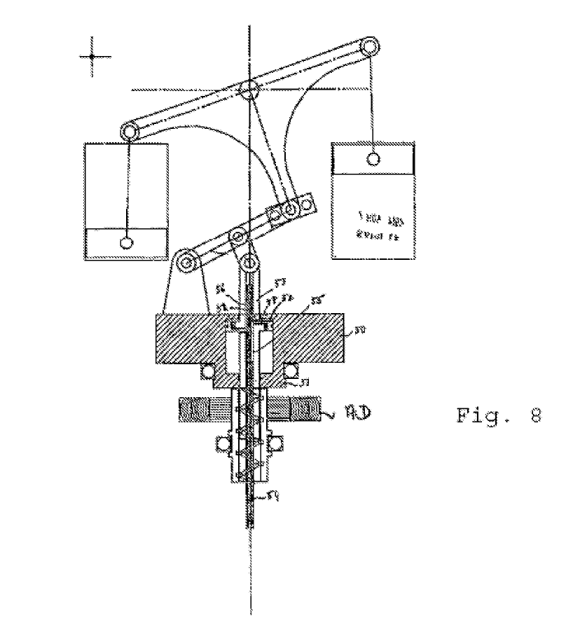

In the example illustrated in FIG. 7, utilization of the torque in order to generate a force which opposes the force induced by the radial force is achieved by means of a helicoidal mechanical system. The transmission shaft of the crankshaft 30 is separated into two components designated as main section 31 and secondary section 32. These sections are hollow and crossed by the rod 33 for adjusting the inclination of the oscillating structure 34.

The main section 31:
is directly driven into rotation by the oscillating structure 34 and via the jointed fork 35 on the plate 36 of the crankshaft 30 via the clevis 37,
is connected to the adjustment rod 33 by a fluted assembly which only allows an axial displacement of one relatively to the other (therefore relative blocking in rotation of both components) and is supported by the case of the motor, via a bearing 39 or ideally a ball bearing, and immobilized axially relatively to the case.

The secondary section 32:
transmits the engine torque towards the use (gearbox, wheels . . . ) via a cog 40,
is connected to the adjustment rod 33 by a helicoidal coupling (screw/nut system) with a wide pitch 41, for example with an effective thread slope of about 20°, so that the movements are reversible (a relative rotation of the main shaft and of the secondary shaft causes axial displacement of the adjustment rod 33 and conversely axial displacement of the rod 33 is possible if a force is exerted on said rod 33)
is also connected to the case of the engine via a bearing 42 or ball bearing, with immobilization in the axial direction.

At the end of the section of the secondary shaft 32, is found a dual effect cylindrical actuator 43, the working chambers of which 44, 45 are connected to each other through a distributor 46 and the piston of which is firmly attached to the adjustment rod 33. This cylinder does not act as an actuator but only as a regulator. Depending on the control, this distributor allows circulation of the hydraulic fluid between the working chambers 44, 45 or on the contrary prevents this circulation.

It is therefore seen that if a positive torque is transmitted by the main section 31 to the secondary section 32, the transmission force will have the effect of changing the relative angular position of both shafts, and thus by having selected the direction of the helix in relationship with the direction of rotation of the engine, the effect of pushing the adjustment rod 38 back towards the oscillating structure. This force therefore opposes the force generated by the radial force, and during normal operation, the regulator promotes either one of these loads in order to reach the required position (self-assistance).

Conversely, upon starting or with engine braking being performed, the torque from the engine is negative, the relative angular positions of both shafts 31, 32 will reverse, and the adjustment rod 38 will be returned to beyond the oscillating structure, corresponding to reducing or cancelling the compression ratio. The (electronic if this is the case) management of the distributor 46 controlling the regulating cylindrical actuator 43 should take into account the different operating configurations, in particular determine the opportunity of declutching the engine in the case of a reduction or inversion of the transmitted torque for a short duration, for example upon changing gear or a short slowing-down.

The fact should be emphasized that the phase shift generated between both shafts 31 and 32 may be obtained very easily, in the desired direction, by making the most out of the inertia or kinetic energy of the rotating masses on the one hand, and of controlled variations of the speed of rotation of the alterno-starter used (AD) (FIG. 8), on the other hand.

Therefore, a simple declutching, stopping and starting means for the engine is made available, while avoiding any system which would operate by friction, by a disengageable gear or any other device. With this solution, it is possible to reduce the risks of wear, the sources of noise and jolts, the production costs, and reliability of the device may be increased.

Starting procedures corresponding to specific configurations are described below:

In the case of a stopped vehicle and with the clutch disengaged, the starting procedure may comprise the following steps:

1/ Setting the crankshaft (inertia flywheel) into rotation by means of the alterno-starter. As the torque is positive from the alterno-starter to the heat engine, the oscillating structure of the engine is therefore automatically placed in the declutched position.

2/ Positioning the secondary rod in a position corresponding to a command of “maximum compression ratio”.

3/ When the speed of rotation of the crankshaft is sufficient, slightly reducing the speed of the alterno-starter for a few fractions of a second: the inertia flywheel having accumulated some kinetic energy, the slowing-down of the alterno-starter has the effect of reversing the direction of transmission of the torque; it becomes positive from the main shaft to the secondary shaft, which has the effect, by means of the helicoidal connection, of pushing the adjustment rod back, and thus inclining the oscillating structure in order to bring it into its normal engine operating position.

4/ Returning the speed of the alterno-starter to its initial speed.

5/ If the engine starts normally, having the secondary rod controlled by the on-board computer according to the normal operating cycle, the alterno-starter is then disabled or operates as a generator.

6/ If the engine does not start (the set speed not being attained after a determined time), returning the driving rod to its “zero compression ratio” position: as the crankshaft has lost speed, the torque again becomes positive from the secondary shaft to the primary shaft, which has the effect of bringing the engine back into the declutched position, rapidly. The starting procedure then resumes at point 1/.

It is important to note that even in the case of unsuccessful starting, a second attempt may be carried out immediately, by benefiting from the residual kinetic energy contained in the crankshaft which is always in rotation; these different phases occur without any parasitic noise (no meshing of cogs), except for a few slight variations in the speed of the alterno-starter.

In the case of a hybrid motorization vehicle, with restarting of the heat engine when the vehicle moves in an electric mode, a parallel hybrid traction chain is considered, formed, from the engine towards the wheels, by: a self-disengageable axial cylinder heat engine, a transmitter/receiver energy converter such as an electric motor, a dry or wet type clutch, a transmission unit with a variable gear ratio such as a gearbox.

With the vehicle operating in an electric mode, the starting procedure may comprise the following operating phases

1/ the heat engine is then in the declutched position, the crankshaft is directly coupled to the electric motor and already rotates at a certain speed of rotation.

2/ The main clutch of the vehicle (a conventional dry or wet type clutch, located between the electric motor and the gearbox) is open for a short instant required for performing points 3/ to 6/

3/ The electric motor is slightly accelerated in order to impart additional kinetic energy to the crankshaft.

4/ The driving rod is brought to the “maximum compression ratio” position.

5/ The electric motor is slightly decelerated in order to allow reversion of the torque transmission direction, and thereby allowing the control rod to be pushed back, and placing the oscillating structure in the normal position for operating the engine.

6/ If the engine starts normally, control of the driving rod is entrusted to the on-board computer according to the normal operating cycle, this also applies for the electric motor, which may then be disabled or else may operate as a generator. The main clutch is again closed as soon as the speed of the engine has been stabilized in order to avoid any jolt.

7/ If the engine does not start (the set speed is not attained after a determined time), the electric motor resumes its initial speed of rotation, the main clutch is closed, and the secondary rod is returned to its “zero compression ratio” position. As the crankshaft has lost its speed, the torque again becomes positive from the secondary shaft to the primary shaft, which has the effect of bringing the engine back into the declutched position rapidly. The starting procedure then resumes at point 1/

It should be noted that under these circumstances, the engine generally has already rotated and should therefore be hot, limiting the risks of false starting. As earlier, the different starting phases occur without any substantial jolt at the level of the occupants of the vehicle, and without any parasitic noise.

Of course, the invention is not limited to the embodiments described earlier.

Thus, notably, the regulation system may for example be incorporated to the assembly formed by the plate and the first section of the rotary shaft.

In the example illustrated in FIG. 8, the cylindrical cavity of the actuator is directly made in the assembly formed by the plate 50 and the section 51. The piston 52 which slides in this hydraulic cavity is directly attached to the adjustment rod 53. The adjustment rod 53, itself comprises an axial cylindrical cavity in which a secondary rod 54 sealably slides, acting as a drawer of the distributor associated with the actuator. This rod at one of its ends has axial grooves 55-56 intended to cooperate with channels made in the rod 53 and in the piston 52 in order to form said distributor. The distributor associated with the actuator comprises anti-return valves. The anti-return valves used in this distributor are housed in the piston 52.

An easily controllable compact assembly is thereby obtained by means of an actuator causing displacement of the secondary rod 54.

1-24. (canceled)

25. A device for converting a linear movement into a rotational movement, this device comprising:
a fixed structure
a rotary shaft which may be driving in the case of an engine and driven in the case of a pump, and the rotary shaft having a main axis XX′
at least one cylinder with an axis X₁X′₁ distinct from the main axis XX′, this cylinder being fixed relatively to the fixed structure
at least one piston slidably mounted inside said cylinder, this piston comprising a load-spreading point
an oscillating structure comprising an appendage of axis YY′, this structure being mounted so as to oscillate around a supporting point firmly attached to the fixed structure and located on said main axis XX′
a Cardan joint or analogous link placed between the fixed supporting point and a corresponding attachment point of the oscillating structure for ensuring translational fixedness of the oscillating structure while preventing its rotation around its YY′ axis,
at least one small connecting rod transmitting the forces between the load-spreading point of the piston and a load-spreading point provided on the oscillating structure, so that when the piston moves in the cylinder, the axis YY′ of the oscillating structure sweeps through a cone of axis XX′ and of apex O and a load-spreading point provided on the appendage follows a circle of centre C located on the XX′ axis and with radius R
a crankshaft associated with the rotary shaft and which may rotate around the XX′ axis, this crankshaft comprising a load-spreading point, decentred relatively to the main axis XX′
jointed connecting means between the load-spreading point located on the appendage of the oscillating structure and the load-spreading point located on the crankshaft
wherein
said jointed connecting means comprises at least two joints connected to each other through a connecting member, both of these joints being with axes parallel to each other and perpendicular to said main axis XX′
said device comprising an adjustment device involving an actuator comprising a jointed actuation unit on said connecting member so as to cause tipping over of said rigid connecting member and accordingly a variation of said radius R, and of the compression ratio and/or cylinder capacity of the device.

26. The device according to claim 25, wherein the actuation unit either consists in the rotary shaft, said shaft being rotatably mounted while being axially mobile, actuation means being provided for axially displacing said shaft either in a cylindrical actuator positioned between said connecting means and said crankshaft or incorporated to said shaft.

27. The device according to claim 25, said connecting means consists in a connecting fork and in that the crankshaft comprises a rotating circular plate of axis XX′ provided with two diametrically opposite lugs forming a jointed yoke and in that said fork comprises on one side two parallel lugs cooperating with the two lugs of the plate in order to form a first joint, and, on the other side, a load-spreading link comprising a ring-shaped bearing, mounted on the fork so as to pivot around an axis ZZ′ perpendicularly to the axis of rotation of said bearing, the central crown of the bearing being firmly attached to the protrusion of the oscillating structure.

28. The device according to claim 27 wherein a section of axis YY′ firmly attached to the oscillating structure is closely engaged into the free space delimited by the central crown.

29. The device according to claim 27, wherein said fork is rigid and in that both lugs of the plate of the oscillating structure are diametrically opposite.

30. The device according wherein the fork is produced in two portions jointed to each other by a central joint and in that the plate of the oscillating structure comprises a decentred joint yoke, the driving shaft is tubular and delimits an axial passage through which an adjustment rod engages and slides axially, one of the ends of which is connected to the central joint via a connecting rod, one end of which is jointed to the rod while the other one is jointed to said central joint and in that the oscillating structure may occupy a position in which its base is perpendicular to the XX′ axis and remains stationary while the crankshaft may continue to rotate freely.

31. The device according to claim 30 wherein the transmission shaft of the crankshaft is separated into two hollow sections crossed by the adjustment rod, i.e. a main section firmly attached to the plate and connected to the adjustment rod by means of a fluted assembly allowing relative axial displacement and a secondary section connected to the adjustment rod by means of helicoidal coupling, said secondary section being firmly attached to a dual action cylindrical actuator, the chambers of which are connected to each other and the piston of which is firmly attached to the adjustment rod, the distributor being capable of allowing or preventing circulation of fluid between both chambers of the cylindrical actuator and in that the assembly comprising the dual action cylindrical actuator and the hydraulic circuit comprising the distributor is integrated to the main section and/or to said plate.

32. The device according to claim 31 wherein the cavity of the cylindrical actuator is made in the assembly formed by the plate and the section, the piston which slides in this hydraulic cavity is directly attached to the adjustment rod, the adjustment rod comprises an axial cylindrical cavity in which a secondary rod slides sealably, acting as a drawer of the distributor and having at one of its ends axial grooves intended to cooperate with channels made in the rod and in the piston in order to form said distributor.

33. The device according to claim 31 wherein the distributor associated with the cylindrical actuator comprises anti-return valves housed in the piston.

34. The device according to claim 25, comprising means for varying the value of the radius R so that the efficiency of the engine is permanently adjusted in an optimum way, i.e. this engine operates at a maximum compression ratio, while remaining below that for occurrence of the detonating combustion phenomenon, commonly called pinking.

35. The device according to claim 25, comprising means for varying the radius R according to the strength of the mixture admitted into the cylinders to a command from the operator, to the engine speed, to the engine torque or the temperature of the burnt gases, the value of the radius R being adjustable once and for all in the factory so as to correspond to a type of engine operation or by the operator when the engine is stopped in order to take into account the type of fuel used.

36. A method for starting an axial cylinder engine according to claim 31, comprising the following steps:
setting the crankshaft into rotation by means of an alterno-starter so that the oscillating structure of the engine is in the declutched position
positioning the secondary rod in a position corresponding to a maximum compression ratio command
when the speed of rotation of the crankshaft is sufficient, reducing the speed of the alterno-starter for a few fractions of a second, so that the oscillating structure positions itself in the normal operating position
returning the alterno-starter to its initial speed
when the engine starts, disabling the starter function of the alterno-starter and managing the control of the secondary rod with an on-board computer for a normal operating cycle of the engine.

37. A method for starting a heat engine according to claim 31, in the case when it is used in a hybrid motorization vehicle comprising an electric motor, the vehicle initially operating in an electric mode, the heat engine being in a declutched position, the crankshaft being coupled to the electric motor and already rotating at a certain speed of rotation,
said method comprising the following operating phases:
1/ opening the clutch of the vehicle for a short instant
2/ accelerating the electric engine in order to impart additional kinetic energy to the crankshaft
3/ positioning the secondary shaft into a position corresponding to a maximum compression ratio
4/ decelerating the electric motor in order to reverse the direction of transmission of the torque and cause displacement of the control rod in order to place the oscillating structure in the normal operating position
5/ if the engine starts, controlling the secondary rod with an on-board computer for normal operation, and disabling the electric motor
6/ if the engine does not start, resetting the electric motor to its initial speed of rotation, closing the main clutch and returning the secondary rod to the “zero compression ratio” position, the starting procedure may then be repeated.
